(19) United States
(12) Patent Application Publication
(10) Pub. No.: US 2007/0277167 A1
(43) Pub. Date: Nov. 29, 2007

(54) SYSTEM AND METHOD FOR COMPUTER SYSTEM MAINTENANCE

(75) Inventors: Max D. Smith, Tucson, AZ (US); David C. Reed, Tucson, AZ (US); Philip R. Chauvet, Tucson, AZ (US); Michael R. Scott, Tucson, AZ (US)

Correspondence Address: SCULLY, SCOTT, MURPHY, & PRESSER, 400 GARDEN CITY PL, GARDEN CITY, NY, 11530, US

(73) Assignee: INTERNATIONAL BUSINESS MACHINES CORPORATION, Armonk, NY (US)

(21) Appl. No.: 11/419,860

(22) Filed: May 23, 2006

(51) Int. Cl. G06F 9/44

(52) U.S. Cl. 717/168

(57) ABSTRACT

A method of providing maintenance for a software program residing on a customer's computer system enables a customer to easily determine if there are any available updates for the software program, whether the available updates, if any, have been downloaded, which updates, if any, have been installed, and which installed updates, if any, have been activated. The method includes searching an active storage area on the customer's computer system while the software program is executing to determine the particular version of the software program. The method further includes searching a database of a software provider that provided the software program to determine if there is any update available for the software program, and if any update is available, downloading the update to the customer's computer system and installing the update.

### TECHNICAL FIELD

The invention relates generally to computer system maintenance, and more particularly to a utility that searches a customer's computer system to determine a maintenance level for each software program on the customer's computer system, and assists the customer in automatically maintaining each software program.

### BACKGROUND OF THE INVENTION

A variety of computer system maintenance utilities currently exists. For example, Microsoft Windows® includes an update utility that searches the windows registry (i.e., a local database) on a user's computer to determine the current maintenance level of the installed programs. The utility then compares the information found in the registry to information stored on a master software database that includes a list of currently available updates and patches. This utility does not determine if the updates and/or patches are properly installed or if they have been properly activated.

Another utility maintains software systems by using a predefined triggering event. The triggering event is related to the performance of the software, the last time the software was updated, or when changes are made to the configuration of the software.

Still another utility involves a problem reporting feature. This utility allows a user to manage problems with software based on the problem impact. However, this utility does not automatically search for fixes to reported problems.

A current method of software maintenance involves using timed maintenance on a computer system. The method involves identifying times when a computer system is inactive and performing maintenance at that time. The triggering event relates to performance, last time of maintenance update, or changes to system configuration.

### SUMMARY OF THE INVENTION

The invention relates generally to computer system maintenance, and more particularly to a utility that searches a customer's computer system to determine a maintenance level for each software program on the customer's computer system, and assists the customer in automatically maintaining each software program.

In one aspect, the invention involves a method of providing maintenance for a software program residing on a customer's computer system. The method includes searching an active storage area on the customer's computer system while the software program is executing to determine a maintenance level of the software program, searching a database of a software provider that provided the software program to determine if there is any update available for the software program based on the determined maintenance level, and if any update is available, downloading the update to the customer's computer system and installing the update.

In one embodiment, the update includes one or more of: an updated version of the software program, a patch for the software program, or a fix to a known error in the software program.

In another embodiment, the method further includes searching a memory dump file created by the software program on the customer's computer system to determine the maintenance level of the software program. The method still further includes searching a mass storage device for updates that have been downloaded but not installed. The method yet further includes providing a status of the updates for the software program.

In one embodiment, the status includes one or more of: a list of any available updates for the software program, whether the available updates, if any, have been downloaded, which updates, if any, have been installed, and which installed updates, if any, have been activated.

In still another embodiment, the method further includes intercepting an error message corresponding to an error generated by the software program, searching the database of the software provider to determine if the error is a known error, if the error is a known error, determining if there is an available fix for the known error and if there is an available fix for the known error, downloading and installing the available fix for the known error.

In yet another embodiment, the method includes receiving information describing an error generated by the software program, in response to receiving the information, searching the database of the software provider to determine if the error is a known error, if the error is a known error, determining if there is an available fix for the known error, and if there is an available fix for the known error, downloading and installing the available fix for the known error. In another embodiment, searching an active storage area includes searching one or more of: dynamic link libraries, program headers, or executables files for one or more of: revision history, timestamp, program instructions, module length, build date, or file size.

In another aspect, the invention involves a program storage device readable by a machine, tangibly embodying a program of instructions executable by the machine to perform method steps of providing maintenance for a software program residing on a customer's computer system. The method steps include searching an active storage area on the customer's computer system while the software program is executing to determine a maintenance level of the software program, searching a database of a software provider that provided the software program to determine if there is any update available for the software program based on the determined maintenance level, and if any update is available, downloading the update to the customer's computer system and installing the update.

In one embodiment, the update includes one or more of: an updated version of the software program, a patch for the software program, or a fix to a known error in the software program.

In another embodiment, the method steps further include searching a memory dump file created by the software program on the customer's computer system to determine the maintenance level of the software program. The method steps still further include searching a mass storage device for updates that have been downloaded but not installed. The method steps yet further include providing a status of the updates for the software program.

In one embodiment, the status includes one or more of: a list of any available updates for the software program, whether the available updates, if any, have been downloaded, which updates, if any, have been installed, and which installed updates, if any, have been activated.

In still another embodiment, the method steps further include intercepting an error message corresponding to an error generated by the software program, searching the database of the software provider to determine if the error is a known error, if the error is a known error, determining if there is an available fix for the known error and if there is an available fix for the known error, downloading and installing the available fix for the known error.

In yet another embodiment, the method steps include receiving information describing an error generated by the software program, in response to receiving the information, searching the database of the software provider to determine if the error is a known error, if the error is a known error, determining if there is an available fix for the known error, and if there is an available fix for the known error, downloading and installing the available fix for the known error. In another embodiment, searching an active storage area includes searching one or more of: dynamic link libraries, program headers, or executables files for one or more of: revision history, timestamp, program instructions, module length, build date, or file size.

In still another aspect, the invention involves a system for providing maintenance for a software program residing on a customer's computer system. The system includes means for searching an active storage area on the customer's computer system while the software program is executing to determine a maintenance level of the software program, means for searching a database of a software provider that provided the software program to determine if there is any update available for the software program based on the determined maintenance level, and means for downloading the update to the customer's computer system and installing the update, if any update is available.

In one embodiment, the update includes one or more of: an updated version of the software program, a patch for the software program, or a fix to a known error in the software program.

In another embodiment, the system further includes means for searching a memory dump file created by the software program on the customer's computer system to determine the maintenance level of the software program. The system still further includes means for searching a mass storage device for updates that have been downloaded but not installed. The system yet further includes means for providing a status of the updates for the software program.

In other embodiments, the status includes one or more of: a list of any available updates for the software program, whether the available updates, if any, have been downloaded, which updates, if any, have been installed, and which installed updates, if any, have been activated.

In another embodiment, the system includes means for intercepting an error message corresponding to an error generated by the software program, means for searching the database of the software provider to determine if the error is a known error, means for determining if there is an available fix for the known error, if the error is a known error, and means for downloading and installing the available fix for the known error, if there is an available fix for the known error.

In still another embodiment, the system includes means for receiving information describing an error generated by the software program, means for searching the database of the software provider to determine if the error is a known error, in response to receiving the information, means for determining if there is an available fix for the known error, if the error is a known error, and means for downloading and installing the available fix for the known error, if there is an available fix for the known error.

In yet another embodiment, the means for searching an active storage area searches one or more of: dynamic link libraries, program headers, or executables files for one or more of: revision history, timestamp, program instructions, module length, build date, or file size.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustrative schematic diagram of a computer network on which a computer system maintenance utility is implemented, according to one embodiment of the invention.

FIG. 2 is an illustrative flow diagram of the steps for determining a maintenance level for a computer program residing on a customer's computer system, according to one embodiment of the invention.

FIG. 3 is an illustrative flow diagram of the steps for handling program errors, according to one embodiment of the invention.

FIG. 4 is an illustrative flow diagram of the steps for handling software program errors by inputting error symptoms, according to one embodiment of the invention.

### DETAILED DESCRIPTION

The invention relates generally to computer system maintenance, and more particularly to a utility that searches a customer's computer system to determine a maintenance level for each software program on the customer's computer system, and assists the customer in automatically maintaining each software program. The maintenance level of a particular software program is a list of the updates, patches, and fixes that have been downloaded and installed for that particular software program.

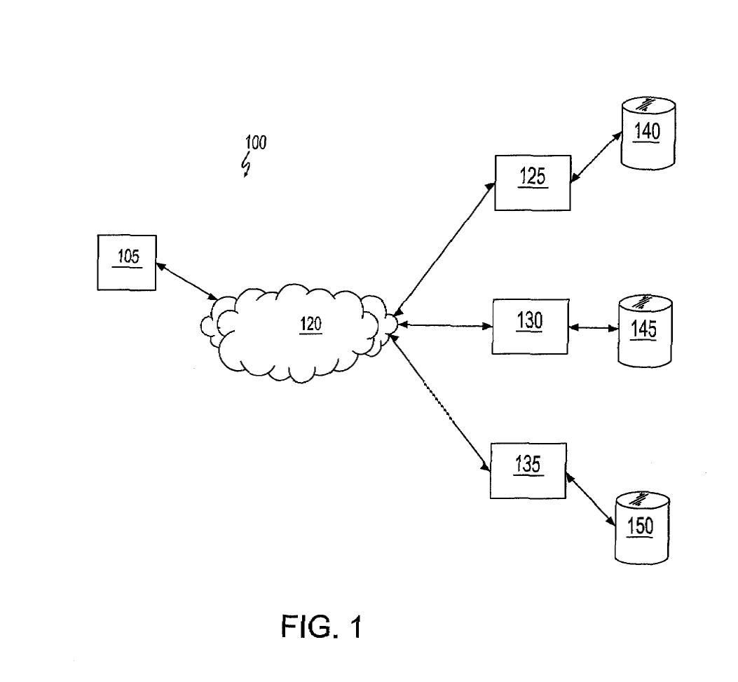

Referring to FIG. 1, in one embodiment, a schematic diagram of a computer network system 100 on which a computer system maintenance utility is implemented is shown. The computer network system 100 includes a network 120 (such as the internet, an intranet, or World Wide Web, for example, and may be wired or wireless), a customer computer system 105, and software provider computer systems 125, 130, and 135. The software provider computer systems 125, 130, and 135 are each in communication with software maintenance databases 140, 145, and 150 respectively. In other embodiments, the software maintenance databases 140, 145, and 150 reside on the customer computer system 105 and the software provider computer systems 125, 130, and 135 respectively. In still other embodiments, more customer computer systems and more or less software provider computer systems can be in communication with the network 120.

In some embodiments, the customer computer system 105 may be a desk top computer system, a laptop computer, personal data assistant (PDA), or any other computing device that includes a processor or central processing unit (CPU), random access memory (RAM), a mass storage device (e.g., hard disk), and is capable of executing software programs.

In a preferred embodiment, the maintenance utility is software program that is downloaded and installed on the customer computer system 105. The programming language that the maintenance utility is written in is irrelevant to its function. However, the maintenance utility can be implemented in a standard high level language such as C, C++, JAVA, PLX, etc.

The maintenance utility, when executed, functions transparently to monitor other executing software programs. When a particular software program is executing (i.e., loaded and running in RAM) on the customer computer system 105, the maintenance utility searches or scans an active storage area (i.e., RAM) on the customer's computer system 105 to determine the particular maintenance level of a software program. The maintenance level (i.e., version, revision, release level, etc.) of a software program is a list of the updates, patches, or fixes to known errors that have been downloaded and installed for that particular software program.

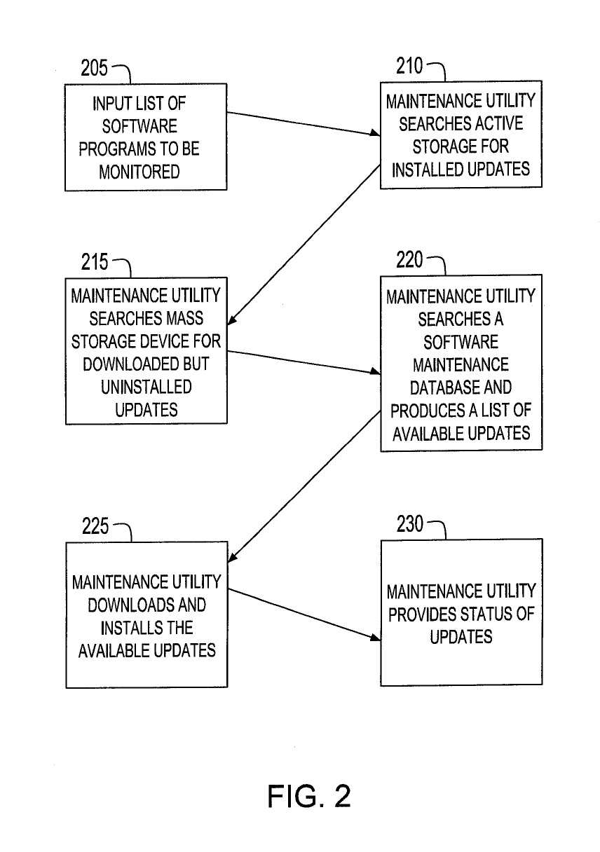

Referring to FIGS. 1 and 2, in a preferred embodiment, in operation, a user (e.g., a system administrator) inputs (via a graphical user interface) a list of the software programs that are to be monitored by the maintenance utility (Step 205). In one embodiment, the graphical user interface includes a check box list of all installed software programs. To select the software programs that are to be monitored, the customer simply checks the check box next to the software application. In other embodiments, the maintenance utility automatically monitors all software programs installed on the customer computer system 105.

When a particular software program is executed, the maintenance utility determines the maintenance level of the particular software program by searching or scanning (in active storage) various software product modules associated with the software program (e.g., dynamic link libraries), or headers (i.e., eyecatcher) in the software code (i.e. executable files) for a revision history or code timestamp (Step 210). If there is no header, the maintenance utility can check module length, build date, time, file size, or other attribute that varies with revision. The maintenance utility can also search the program instructions of the executable code. For example, the latest patch or code change may have changed three lines of source code that resulted in ten lines of assembler instructions being altered at a particular offset into a particular module. The hexadecimal representation of this section of the module in a memory dump file can be compared to an assembly listing of the module to determine if altered lines of code are consistent with the new maintenance level. If they are not, the maintenance utility can go back to the second oldest patch or code change and search and compare again to see if this patch/code change has been applied. All code changes are (by common programming standard) applied in chronological order of their release date, and the maintenance level corresponds to the newest level of patch or code change that has been installed. Therefore, once the newest level of patch or code change is determined, the maintenance level is known.

The maintenance utility also searches the mass storage device (e.g., hard disk) of the customer computer system 105 to obtain a list of the updates have been downloaded and compares the list to the maintenance level to determine if there are any updates that have been downloaded but not installed (Step 215). In another embodiment, the maintenance utility also searches a memory dump file or a temporary data file that is created by the software program and stored on the customer's computer system 105 to determine the particular version of the software program.

This method of determining the maintenance level of a software program differs significantly from existing methods in that existing methods involve searching a database stored on the customer computer, such as the Microsoft Windows® registry. A problem with this method is that an entry corresponding to a particular update in a database is only an indication that the particular update was downloaded and installed. The update may have been installed incorrectly, or installed correctly but not activated, such as by a system reset, for example. Determining the maintenance level using the method of the instant invention allows a customer to know exactly what updates have been downloaded, which downloaded updates have been installed, and which installed updates have been properly activated.

If the database or registry that tracks maintenance updates indicates that a code change or patch has been applied, but the search executed by the maintenance utility described above determines that code change or patch has not been applied, then the patch or code change is not properly activated. If these two sources agree, then the code change or patch has been properly activated.

In other embodiments, for products that do not use a database or registry to track updates, the source code stored in mass storage is compared to its representation in memory (RAM) that is currently loaded (during execution). The maintenance utility will flag any difference and the determine the maintenance level of the two sources. The proper activation of the update is then product specific and the varies by source but will generally involve reloading the program from mass storage to memory (RAM) and may, or may not, require a restart of the application and/or the software subsystem.

The maintenance utility next searches a software maintenance database (e.g., software maintenance database 140, 145, or 150) of the software provider that supplied the particular software program for updates that are not listed in the maintenance level (including updates that have been downloaded but not installed). The maintenance utility then produces a list of updates that are available for the software program (Step 220). An update includes an updated version of the particular software program, a patch for the particular version of the software program, or a fix to a known error in the particular version of the software program that has not already been downloaded an installed.

In one embodiment, the when the customer purchases the maintenance utility, a license to access the software maintenance databases (e.g., software maintenance database 140, 145, or 150) of the participating software providers is included. In other embodiments, the customer purchases the maintenance utility and purchases a separate license to access each software maintenance database for the programs the customer wants to maintain. In some embodiments, a license includes registration and access code that allows the maintenance utility to access the updates on a software maintenance databases (e.g., software maintenance database 140, 145, or 150). Registration can occur at the time the maintenance utility is installed. The maintenance utility would transmit the proper access code (or password) to access a software maintenance database.

In still other embodiments, the program executing on the customer computer system 105 is registered with a unique Id that is associated with a customer number and customer computer system identifier (the customer may have multiple systems, each of which would be handled uniquely as they may not be at the same levels). The unique Id is used to authenticate the proprietary database behind an appropriate firewall where the customer's license information and system records are kept. The software maintenance databases (e.g., 140, 145, and 150) are similarly protected to insure their integrity and accuracy.

If any updates are available, the maintenance utility automatically initiates downloading of the updates to the customer computer system 105 (via a TCP/IP communication protocol) and installs the update (Step 225).

After any updates have been installed, the maintenance utility provides a message (e.g., a pop-up window) including the status of the most recent updates and any specific instructions regarding activating the updates (Step 230), such as requiring a computer system reboot, for example.

In another embodiment, the maintenance utility provides a status of the software program maintenance level before downloading any updates. The status includes a list of any available updates for the version of the software program, whether the available updates, if any, have been downloaded, whether the downloaded updates, if any, have been installed, and whether the installed updates, if any, have been activated. The status also includes a list of bad updates and whether they have been downloaded and installed on the customer computer system 105. A bad update is an update, patch, or fix to a known error that includes an error, and should not be installed.

The maintenance utility then allows a customer (or system administrator) to select the actions he/she wants executed. For example, if there are any updates that have not been downloaded, the customer can instruct the maintenance utility to download any or all of them. If there are updates that have been downloaded to the customer computer system 105, but not installed, the customer can instruct the maintenance utility to install them. If there are updates that have been downloaded and installed, but not properly activated, the customer can instruct the maintenance utility to properly activate the updates. If there are bad/faulty updates that have been previously installed, the customer can instruct the maintenance utility to uninstall the bad/faulty updates.

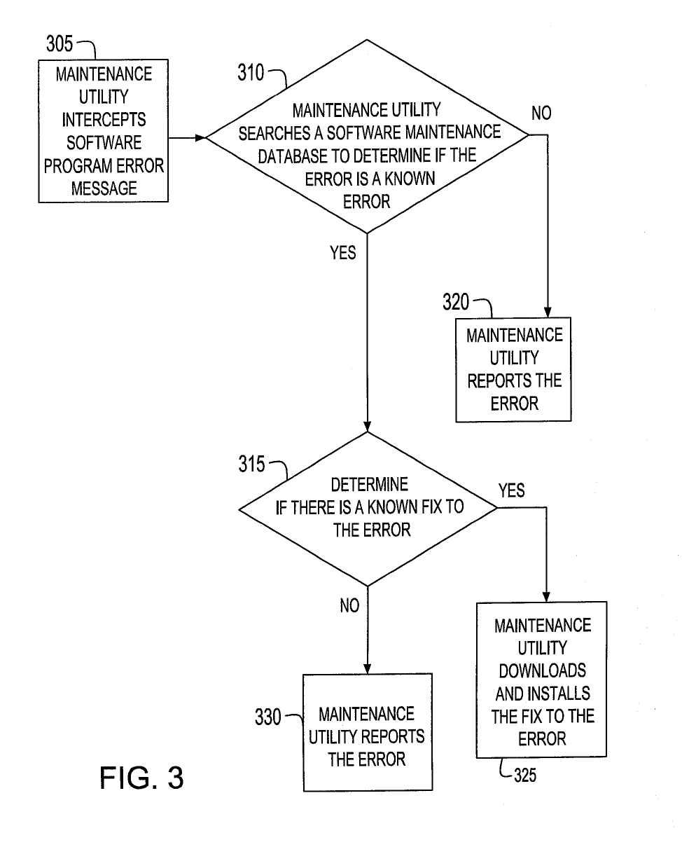

Referring to FIG. 3, in one embodiment, a flow diagram of the steps for handling program errors is shown. During software program execution, the maintenance utility intercepts error messages corresponding to errors generated by the particular version of the software program executing on the customer computer system 105 (Step 305). After the maintenance utility intercepts an error message, the maintenance utility searches the software maintenance database (e.g., software maintenance database 140, 145, or 150) of the software provider that provides the software to determine if the error is a known error (Step 310). If the error is a known error, the maintenance utility determines if there is an available fix for the known error (315). If the error is an unknown error, the maintenance utility reports the error to the software provider (e.g., via email or other communication method) (Step 320).

If the error is a known error and there is an available fix for the known error, the maintenance utility downloads and installs the available fix for the known error (325). If the error is a known error and there is no available fix, the maintenance utility reports the error to the software provider (Step 330)

In another embodiment, before downloading the available fix for the known error, the maintenance utility will notify the user via email, pager, instant message, etc. that a fix for the known error has been found. Thereafter, the customer can instruct the maintenance utility to download the fix at any time. In still another embodiment, the maintenance utility displays a status of the error maintenance. The status of the error maintenance includes the name of the software program, the error the occurred, the status of the error (i.e., known or unknown), the available fix for the error, if any, and the severity of the error and how critical the fix is. The customer then has the option of selecting which fixes he/she wants to download and install.

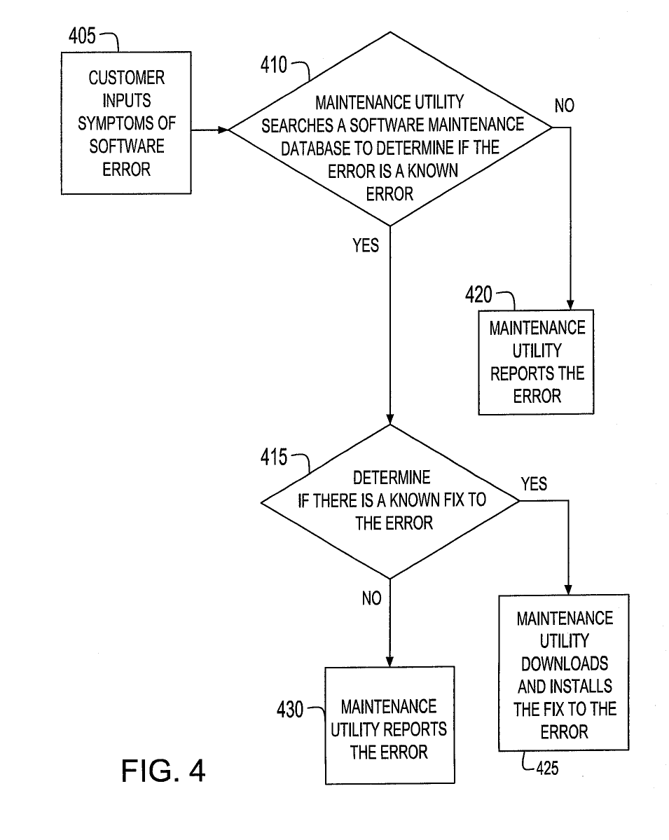

Referring to FIG. 4, in still another embodiment, a flow diagram of the steps for handling software program errors by inputting error symptoms is shown. The maintenance utility provides a graphical user interface that allows a user to enter information describing symptoms of a software program error. The graphical user interface can include a field for text entry, a drop down menu of selectable error symptoms, and a check box list of selectable error symptoms.

First, the customer enters the description/symptoms of the error (Step 405). Next, the maintenance utility searches the software maintenance database (140, 145, or 150) of the software provider that provides the software to determine if the error is a known error (Step 410). If the error is a known error, the maintenance utility determines if there is an available fix for the known error (415). If the error is an unknown error, the maintenance utility reports the error to the software provider (e.g., via email or other communication method) (Step 420).

If the error is a known error and there is an available fix for the known error, the maintenance utility downloads and installs the available fix for the known error (425). If the error is a known error and there is no available fix, the maintenance utility reports the error to the software provider (Step 430)

Referring again to FIG. 1, when the customer computer system 105 is not consistently connected to the network 120 (for security reasons, or because the customer computer system 105 is a mobile computer), the maintenance utility still searches an active storage area (i.e., RAM) on the customer's computer system 105 to determine the particular maintenance level as described herein. However, until the customer computer system 105 reestablishes a connection to the network 120, the maintenance utility cannot search the software maintenance database (e.g., software maintenance database 140, 145, or 150) of the software provider that provided the particular software program to determine if there is any update available for the software program. In one embodiment, a local copy of the software maintenance database (140, 145, or 150) is downloaded to the customer computer system 105. The maintenance utility can still search for updates when the customer computer system 105 is not connected to the network 120. The maintenance utility compiles a list of the updates that need to be downloaded, and downloads them at a time when the customer computer system 105 is connected to the network 120. In this embodiment, the local copy of the software maintenance database (140, 145, or 150) must be updated (downloaded) to the customer computer system 105 frequently to ensure the information in the database is correct. In another embodiment, the maintenance utility can send a batch query at a predetermined time (when the customer computer system 105 is connected to the network 120) to search the software maintenance databases 140, 145, 150. Further, the maintenance utility would download all available updates at one time and install them on the customer computer system 105 using one of the methods previously described.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A method of providing maintenance for a software program residing on a customer's computer system, comprising:
searching an active storage area on the customer's computer system while the software program is executing to determine a maintenance level of the software program;
searching a database of a software provider that provided the software program to determine if there is any update available for the software program based on the determined maintenance level; and
if any update is available, downloading the update to the customer's computer system and installing the update.

2. The method of claim 1 wherein the update comprises one or more of: an updated version of the software program, a patch for the software program, or a fix to a known error in the software program.

3. The method of claim 1 further comprising searching a memory dump file created by the software program on the customer's computer system to determine the maintenance level of the software program.

4. The method of claim 1 further comprising searching a mass storage device for updates that have been downloaded but not installed.

5. The method of claim 1 further comprising providing a status of the updates for the software program.

6. The method of claim 5 wherein the status comprises one or more of: a list of any available updates for the software program, whether the available updates, if any, have been downloaded, which updates, if any, have been installed, and which installed updates, if any, have been activated.

7. The method of claim 1 further comprising:
intercepting an error message corresponding to an error generated by the software program;
searching the database of the software provider to determine if the error is a known error;
if the error is a known error, determining if there is an available fix for the known error; and
if there is an available fix for the known error, downloading and installing the available fix for the known error.

8. The method of claim 1 further comprising:
receiving information describing an error generated by the software program;
in response to receiving the information, searching the database of the software provider to determine if the error is a known error;
if the error is a known error, determining if there is an available fix for the known error; and
if there is an available fix for the known error, downloading and installing the available fix for the known error.

9. The method of claim 1 wherein searching an active storage area comprises searching one or more of: dynamic link libraries, program headers, or executables files for one or more of: revision history, timestamp, program instructions, module length, build date, or file size.

10. A program storage device readable by a machine, tangibly embodying a program of instructions executable by the machine to perform method steps of providing maintenance for a software program residing on a customer's computer system, the method steps comprising:
searching an active storage area on the customer's computer system while the software program is executing to determine a maintenance level of the software program;
searching a database of a software provider that provided the software program to determine if there is any update available for the software program based on the determined maintenance level; and
if any update is available, downloading the update to the customer's computer system and installing the update.

11. The program storage device of claim 10 wherein the update comprises one or more of: an updated version of the software program, a patch for the software program, or a fix to a known error in the software program.

12. The program storage device of claim 10 wherein the method steps further comprise searching a memory dump file created by the software program on the customer's computer system to determine the maintenance level of the software program.

13. The program storage device of claim 10 wherein the method steps further comprise searching a mass storage device for updates that have been downloaded but not installed.

14. The program storage device of claim 10 wherein the method steps further comprise providing a status of the updates for the software program.

15. The program storage device of claim 14 wherein the status comprises one or more of: a list of any available updates for the software program, whether the available updates, if any, have been downloaded, which updates, if any, have been installed, and which installed updates, if any, have been activated.

16. The program storage device of claim 10 wherein the method steps further comprise:
intercepting an error message corresponding to an error generated by the software program;
searching the database of the software provider to determine if the error is a known error;
if the error is a known error, determining if there is an available fix for the known error; and
if there is an available fix for the known error, downloading and installing the available fix for the known error.

17. The program storage device of claim 10 wherein the method steps further comprise:
receiving information describing an error generated by the software program;
in response to receiving the information, searching the database of the software provider to determine if the error is a known error;
if the error is a known error, determining if there is an available fix for the known error; and
if there is an available fix for the known error, downloading and installing the available fix for the known error.

18. The program storage device of claim 10 wherein searching an active storage area comprises searching one or more of: dynamic link libraries, program headers, or executables files for one or more of: revision history, timestamp, program instructions, module length, build date, or file size.

19. A system for providing maintenance for a software program residing on a customer's computer system, comprising:
means for searching an active storage area on the customer's computer system while the software program is executing to determine a maintenance level of the software program;
means for searching a database of a software provider that provided the software program to determine if there is any update available for the software program based on the determined maintenance level; and
means for downloading the update to the customer's computer system and installing the update, if any update is available.

20. The system of claim 19 wherein the update comprises one or more of: an updated version of the software program, a patch for the software program, or a fix to a known error in the software program.

21. The system of claim 19 further comprising means for searching a memory dump file created by the software program on the customer's computer system to determine the maintenance level of the software program.

22. The system of claim 19 further comprising means for searching a mass storage device for updates that have been downloaded but not installed.

23. The system of claim 19 further comprising means for providing a status of the updates for the software program.

24. The system of claim 23 wherein the status comprises one or more of: a list of any available updates for the software program, whether the available updates, if any, have been downloaded, which updates, if any, have been installed, and which installed updates, if any, have been activated.

25. The system of claim 19 further comprising:
means for intercepting an error message corresponding to an error generated by the software program;
means for searching the database of the software provider to determine if the error is a known error;
means for determining if there is an available fix for the known error, if the error is a known error; and
means for downloading and installing the available fix for the known error, if there is an available fix for the known error.

26. The system of claim 19 further comprising:
means for receiving information describing an error generated by the software program;
means for searching the database of the software provider to determine if the error is a known error, in response to receiving the information;
means for determining if there is an available fix for the known error, if the error is a known error; and
means for downloading and installing the available fix for the known error, if there is an available fix for the known error.

27. The system of claim 19 wherein the means for searching an active storage area searches one or more of: dynamic link libraries, program headers, or executables files for one or more of: revision history, timestamp, program instructions, module length, build date, or file size.
